(19) United States
(12) Patent Application Publication
(10) Pub. No.: US 2025/0304366 A1
(43) Pub. Date: Oct. 2, 2025

(54) BATTERY UNIT STORAGE WAREHOUSE

(71) Applicant: JGC HOLDINGS CORPORATION, Kanagawa (JP)

(72) Inventors: Noriaki TERAKUBO, Kanagawa (JP); Masatsugu IDO, Kanagawa (JP); Tomohiro SAKURAI, Kanagawa (JP); Keiji TANIGAWA, Kanagawa (JP); Kosuke TAKAISHI, Kanagawa (JP)

(73) Assignee: JGC HOLDINGS CORPORATION, Kanagawa (JP)

(21) Appl. No.: 18/866,063

(22) PCT Filed: May 20, 2022
(86) PCT No.: PCT/JP2022/020952

§ 371 Date: Nov. 14, 2024

(51) Int. Cl. B65G 1/02; E04H 5/02; H02J 3/32

(52) U.S. Cl. CPC B65G 1/02; E04H 5/02; H02J 3/32

(57) ABSTRACT

Provided is a battery unit storage warehouse including: a pallet configured to collectively hold a plurality of battery units in a vertical orientation; a junction box, which is provided for each pallet, and is configured to put together cables of the plurality of battery units; and a rack configured to allow a plurality of pairs of the pallet and the junction box to be placed on the rack.

### TECHNICAL FIELD

The present invention relates to a battery unit storage warehouse.

### BACKGROUND ART

As the amount of electric power consumption is increasing, and the amount of electric power generation by renewable energy, such as solar power generation and wind power generation, is increasing, there has been a growing need to stabilize a balance between supply and demand of electric power. At the same time, as devices that use batteries (storage batteries), such as electric vehicles (EVs), are spreading, a supply quantity of batteries has been increasing.

For example, in Patent Literature 1, there is described a storage system including a plurality of rails or tracks that are arranged in a grid pattern on top of a stack of a plurality of containers.

In Patent Literature 2, there is described a warehouse in which a battery voltage is measured under a state in which a tray containing a plurality of batteries is stored on a shelf by a crane.

In Patent Literature 3, there is described a warehouse in which battery accommodation compartments included in a rack include charging accommodation compartments that allow charging of batteries.

In Patent Literature 4, there is described a storage system in which a connecting portion is provided for a storage apparatus for used battery units, and charging and discharging are managed through recognition of a battery status.

### CITATION LIST

### Patent Literature

[Patent Literature 1]: JP 2020-186133 A
[Patent Literature 2]: JP 3435749 B2
[Patent Literature 3]: JP 2011-193690 A
[Patent Literature 4]: JP 6912125 B1

### SUMMARY OF INVENTION

### Technical Problem

Existing battery storage methods have wasteful spaces, and thus, it has been difficult to achieve high density.

The present invention provides a battery unit storage warehouse capable of storing a plurality of battery units at high density.

### Solution to Problem

According to a first aspect of the present invention, there is provided a battery unit storage warehouse, including: a pallet, configured to collectively hold a plurality of battery units in a vertical orientation; a junction box, which is provided for each pallet, and is configured to put together cables of the plurality of battery units; and a rack, configured to allow a plurality of pairs of the pallets and the junction boxes to be placed on the rack.

According to a second aspect of the present invention, in the first aspect, the battery unit storage warehouse is configured to: allow the battery units placed on the pallet to store electric power, and allow a supply of the electric power from the battery units via the junction box.

According to a third aspect of the present invention, in the second aspect, the battery unit storage warehouse further includes: a power conditioner and a transformer that are connected to the junction box.

According to a fourth aspect of the present invention, in any one of the first to third aspects, the rack is mobile.

### Advantageous Effects of Invention

According to the first aspect of the present invention, the plurality of battery units can be stored at high density.

According to the second aspect of the present invention, electric power can be stored and supplied by using the plurality of battery units.

According to the third aspect of the present invention, it becomes easier to perform an adjustment required when the battery units are connected to other power systems.

According to the fourth aspect of the present invention, it becomes easier to secure a work space for use of a forklift or the like at the time of loading and unloading of the pallet with respect to the rack.

### BRIEF DESCRIPTION OF DRAWINGS

FIG. 1 is a front view for illustrating an example of a battery unit storage warehouse according to an embodiment.

FIG. 2 is a layout view for illustrating an example of arrangement of racks and aisles.

FIG. 3 is a plan view for illustrating an example in which a work space is arranged outside a plurality of racks.

FIG. 4 is a plan view for illustrating an example in which a work space is arranged between the plurality of racks.

### DESCRIPTION OF EMBODIMENTS

Hereinafter, the present invention is described based on the preferred embodiment.

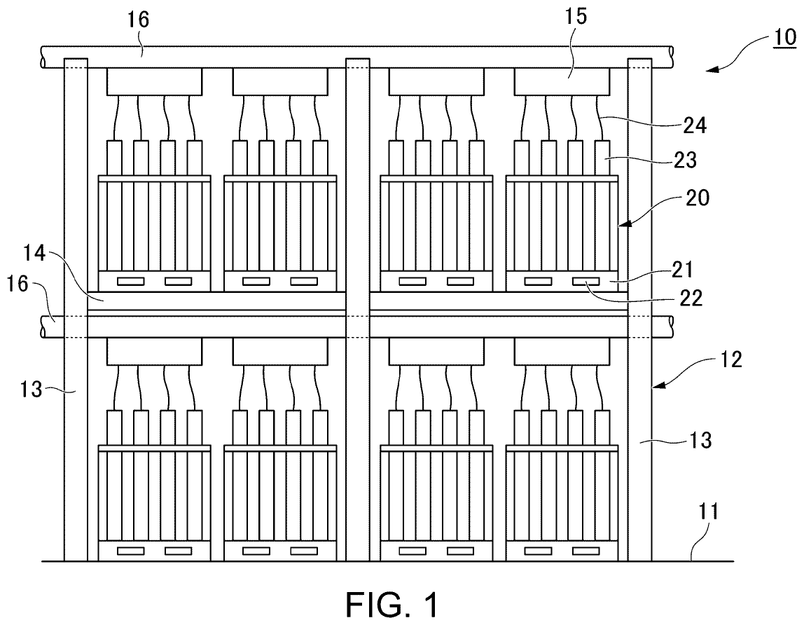

FIG. 1 shows an example of a battery unit storage warehouse 10 according to an embodiment. The battery unit storage warehouse 10 includes: a rack 12 that allows a plurality of pairs of a pallet 20 and a junction box 15 to be placed thereon.

The rack 12 in the illustrated example is placed on a floor 11 of the warehouse. The rack 12 includes pillars 13 that support the rack 12 on the floor 11, and a shelf 14 on which the pallets 20 are placed.

The rack 12 may include at least one shelf 14, or may include two or more shelves 14. When the shelf 14 is omitted on the lowest level of the rack 12, the pallets 20 may be placed on the floor 11. The number of levels of the rack 12 is not particularly limited, but it is preferred that two or more levels be provided for the total of the pallets 20 that can be placed on the floor 11 or the shelf 14. For example, three to five levels may be provided.

The pallet 20 can collectively hold a plurality of battery units 23 in a vertical orientation. Each battery unit 23 to be held by the pallet 20 is arranged, so that a height of the battery unit 23 is larger than a width and a depth of the battery unit 23 included in an occupied area. When the battery units 23 are placed vertically, the occupied area of the battery units 23 can be reduced as compared to a placement area formed by the pallet 20.

In the rack 12, the junction box 15 can be provided for each pallet 20. The junction box 15 is connected to cables 24 so as to put together the cables 24 of the plurality of battery units 23 contained in the pallet 20.

When the pallet 20 holding the battery units 23 is placed on the rack 12, work of connecting the cables 24 and the junction box 15 to each other may be carried out. When the pallet 20 holding the battery units 23 is unloaded from the rack 12, work of disconnecting the cables 24 from the junction box 15 may be carried out.

The rack 12 holds a wiring duct 16 above the pallet 20. The plurality of pallets 20 may be placed on each level of the rack 12. The wiring duct 16 may be provided for each level of the rack 12. In this case, the battery units 23 held by the plurality of pallets 20 placed on the same level of the rack 12 are connected to the same wiring duct 16 through intermediation of the junction boxes 15.

According to the battery unit storage warehouse 10 of the embodiment, the pallet 20 holding the battery units 23 is placed on the rack 12, and thus, a load can be supported by the rack 12. The plurality of battery units 23 can be stored at high density without causing the upper and lower battery units 23 to exert a load on each other.

It is preferred that, a gap through which the air can flow for air cooling be defined around the battery units 23 held by the pallet 20. The battery unit storage warehouse 10 may include a cooling device (not shown), such as a blower or air conditioning equipment.

The battery units 23 placed on the pallet 20 can store electric power. Further, the electric power can be supplied from the battery units 23 via the junction box 15. Thus, the electric power can be stored and supplied through use of the plurality of battery units 23.

The pallet 20 in the illustrated example includes a holding section 21 that holds the battery unit 23. The holding section 21 may have slots 22 into which forks are inserted when a forklift handles the pallet 20.

The holding section 21 of the pallet 20 may include a carrying surface to be arranged below the battery unit 23, and a support section that supports the battery unit 23 from a side of the battery unit 23. The carrying surface of the pallet 20 may be a plate-shaped structure such as a deck board.

The support section of the pallet 20 may be formed of one type or two or more types among columnar, basket-shaped, lattice-shaped, fence-shaped, plate-shaped, and wall-shaped structures. The support section of the pallet 20 may be fixed to the carrying surface, may be removable from the carrying surface or foldable, or may have an opening and closing structure such as a gate. From the viewpoint of air cooling of the battery unit 23, it is preferred that, the support section of the pallet 20 have a ventilation function.

The number of the battery units 23 that the pallet 20 can hold (holding capacity) is not particularly limited, but, for example, the pallet 20 can hold two to ten battery units 23, or three to five battery units 23. The number of the battery units 23 held by the pallet 20 is not particularly limited as long as the number of the held battery units 23 falls within the holding capacity. It is more efficient to place and unload the battery units 23 on and from the rack 12 through use of the pallet 20 that holds the same number of the battery units 23 as the holding capacity.

The battery unit 23 is a unit representing a group of battery structures that can be functionally or physically separable. The battery unit 23 may include a plurality of batteries therein.

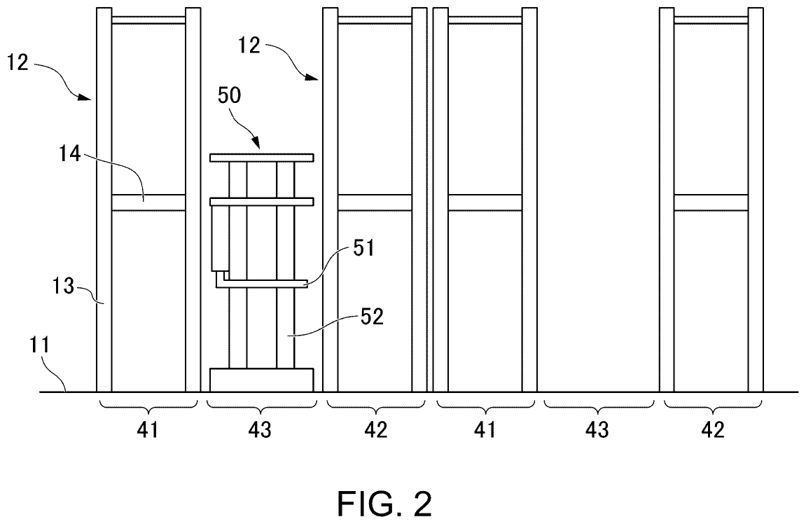

The rack 12 may be mobile or stationary. When the rack 12 is stationary, for example, as illustrated in FIG. 2, the racks 12 and aisles 43 may be arranged. In this example, rack spaces 41 and 42, in which the racks 12 are placed on the floor 11, are provided on both sides of the aisle 43, respectively. The aisle 43 allows a forklift 50 to be operated. The forklift 50 is not particularly limited, but the forklift 50 may be operated by a person or operated in an unattended manner.

It is preferred that, the forklift 50 is a 3-way type capable of changing an orientation of the forks 51 to a front side, a left side, and a right side with respect to a mast 52 capable of raising and lowering the forks 51. Loading and unloading of the pallet 20 with respect to the rack 12 can be performed by directing the forks 51 toward the rack 12 while keeping the forklift 50 stopped on the aisle 43. That is, the aisle 43 adjacent to the rack 12 can be used as a work space for tasks such as replacing the pallets 20 on the rack 12.

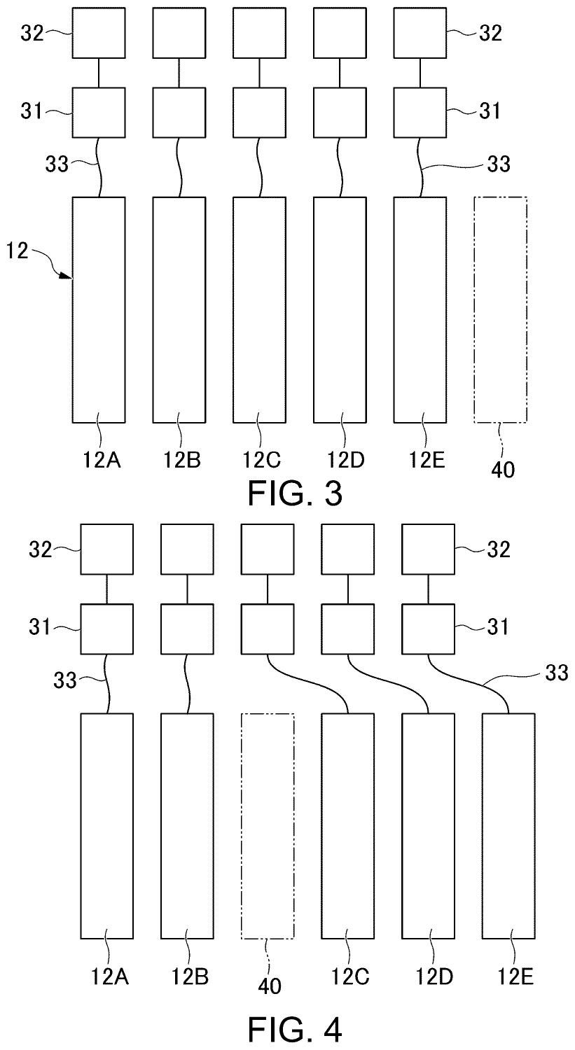

In a case in which the racks 12 are mobile, for example, as illustrated in plan views of FIG. 3 and FIG. 4, when a plurality of racks 12A, 12B, 12C, 12D, and 12E are aligned, a work space 40 may be secured at a location adjacent to the rack 12 or at any location between the racks 12. With this configuration, it becomes easier to secure the work space 40 for use of the forklift 50 or the like at the time of loading and unloading of the pallet 20 with respect to the rack 12.

FIG. 3 shows an example of a case in which the work space 40 is secured adjacent to the rack 12E, and FIG. 4 shows an example of a case in which the work space 40 is secured between the racks 12B and 12C. The present invention is not limited to the illustrated examples, and the location of the work space 40 can be suitably changed to, for example, a location between the racks 12A and 12B, a location between the racks 12C and 12D, or a location between the racks 12D and 12E.

Each rack 12 may include a power conditioner 31 and a transformer 32 that are connected to the junction box 15. This enables adjustment required when the battery units 23 stored in the rack 12 are connected to other power systems.

The power conditioner 31 may have a function of allowing conversion between a direct current in the battery unit 23 and an alternating current in an external power system. The transformer 32 may have a function of allowing transformation between a voltage in the battery unit 23 and a voltage in the external power system.

The rack 12 can be connected to the power conditioner 31 and the transformer 32 through intermediation of, for example, a connecting cable 33. The connecting cable 33 is flexible, and hence can be laid in any orientation between the rack 12 and the power conditioner 31 and the transformer 32.

In order to stabilize the balance between supply and demand of electric power as described above, it is required to adjust a supply amount of electric power and a demand amount of electric power. The adjustment of supply and demand of electric power is carried out at appropriate timing between operators involved in transmission or distribution of electric power (transmission and distribution operators) and operators supplying electric power for adjustment (adjustment power).

The general adjustment power is categorized into a primary adjustment power for controlling a frequency, a secondary adjustment power for restoring a frequency to a standard, and a tertiary adjustment power for adjusting the balance between supply and demand. An adjustment speed is set in accordance with a response time from when the transmission and distribution operator requests the supply of the adjustment power to when the adjustment power is supplied. When a high adjustment speed is required, the adjustment power is sometimes supplied based on information detected locally without requiring a communication line.

For the primary adjustment power, for example, a response time of 10 seconds or shorter is required in some cases. For the secondary adjustment power, for example, a response time of 5 minutes or shorter is required in some cases. For the tertiary adjustment power, for example, a response time of 15 minutes or shorter is required for relatively high-speed settings, and a response time of 45 minutes or shorter is required for relatively low-speed settings, in some cases.

According to the battery unit storage warehouse 10 of the embodiment, electric power is stored in the battery unit 23 in advance, and when the adjustment power is required, the electric power is supplied from the battery unit 23, thereby being capable of shortening the response time. The destination of supply of the adjustment power is not particularly limited, but examples of the destination include a power transmission network and a power distribution network of a power grid.

The battery unit 23 to be stored in the battery unit storage warehouse 10 is not particularly limited, but examples of the battery unit 23 may include the battery unit 23 to be used in electric vehicles (EVs) and the used battery unit 23. For example, the battery units 23 that require storage during the process of selling, lending, or recycling used battery units 23 may be stored in the battery unit storage warehouse 10 and used for electric power supply.

When a plurality of battery units 23 are stored in the battery unit storage warehouse 10, timing for taking out a specific battery unit 23 from the battery unit storage warehouse 10 can be set as appropriate.

For example, when a decline in performance due to aging of the battery unit 23 or other causes is detected, the battery unit 23 may be unloaded from the rack 12 or the pallet 20. The battery unit 23 may be unloaded from the rack 12 or the pallet 20 due to artificial causes such as demand for transfer or lending of the battery unit 23.

Although the present invention has been described above based on the preferred embodiment, the present invention is not limited to the above-mentioned embodiment, and various modifications are possible within a scope not departing from the gist of the present invention. As the modifications, there are given the addition, replacement, omission, and other changes of the constituent elements in each of embodiments.

### INDUSTRIAL APPLICABILITY

The present invention can be utilized for storing and supplying electric power with use of the battery units.

### REFERENCE SIGNS LIST

10: battery unit storage warehouse, 11: floor, 12, 12A, 12B, 12C, 12D, 12E: rack, 13: pillar, 14: shelf, 15: junction box, 16: wiring duct, 20: pallet, 21: holding section, 22: slot, 23: battery unit, 24: cable, 31: power conditioner, 32: transformer, 33: connecting cable, 40: work space, 41, 42: rack space, 43: aisle, 50: forklift, 51: fork, 52: mast

1. A battery unit storage warehouse, comprising:
a pallet, configured to collectively hold a plurality of battery units in a vertical orientation;
a junction box, which is provided for each pallet, and is configured to put together cables of the plurality of battery units; and
a rack, configured to allow a plurality of pairs of the pallet and the junction box to be placed on the rack.

2. The battery unit storage warehouse according to claim 1, wherein
the battery unit storage warehouse is configured to:
allow the battery units placed on the pallet to store electric power, and
allow a supply of the electric power from the battery units via the junction box.

3. The battery unit storage warehouse according to claim 2, further comprising:
a power conditioner and a transformer that are connected to the junction box.

4. The battery unit storage warehouse according to claim 1, wherein
the rack is mobile.

5. The battery unit storage warehouse according to claim 2, wherein
the rack is mobile.

6. The battery unit storage warehouse according to claim 3, wherein
the rack is mobile.
